(19) United States
(12) Patent Application Publication
(10) Pub. No.: US 2007/0239972 A1
(43) Pub. Date: Oct. 11, 2007

(54) Processing internal timestamp counter instructions in reference to external counter

(76) Inventors: Ryuji Orita, Redmond, WA (US); Michael R. Turner, Carnation, WA (US)

Correspondence Address: LAW OFFICES OF MICHAEL DRYJA, 1474 N COOPER RD #105-248, GILBERT, AZ, 85233, US

(21) Appl. No.: 11/400,108

(22) Filed: Apr. 8, 2006

(51) Int. Cl. G06F 9/44

(52) U.S. Cl. 712/226

(57) ABSTRACT

Internal timestamp counter instructions are instead processed in reference to an external counter. A processor receives an instruction to access an internal timestamp counter of the processor, such as from software code containing the instruction that is currently being executed by the processor. The processor processes the instruction, however, in reference to an external counter apart from the processor, instead of in reference to the internal timestamp counter. The code is thus unaware that the instruction is being processed in reference to the external counter instead of in reference to the internal timestamp counter, and does not have to be rewritten or recompiled to take advantage of the external counter. That is, the code still has instructions that are intended to access the internal timestamp counter, and these instructions are instead executed in reference to an external counter, such as a phase-locked loop (PLL) clock of a Northbridge controller.

### FIELD OF THE INVENTION

The present invention relates generally to timestamp counters, and more particularly, to processing internal timestamp counter instructions in reference to an external counter instead.

### BACKGROUND OF THE INVENTION

Modern processors, or central-processing units (CPU's), commonly include timestamp counters. For instance, processors available from Intel Corp., of Santa Clara, Calif., include such timestamp counters. Timestamp counters are counters that allow accessing code to receive a current counter value as a way to timestamp transactions and other types of data. For instance, some operating systems and application programs determine various types of timing calculations by using a processor's timestamp counter.

A multiple-node computing or computerized system is a system in which there are multiple nodes, where each node has one or more processors, its own memory, as well as other computing-oriented peripherals. Application programs running on such multiple-node systems may presume that, regardless of which processor is currently executing a given program, the timestamp counter value will be the same. That is, it may be presumed that the timestamp counters of all the processors over all the nodes are synchronized with one another.

However, synchronization of timestamp counters of different processors is difficult to accomplish. As a result, timing issues may occur where an application program is executed in part by a first processor of a node, and where the application program is then executed in part by a second processor of the same or different node. That is, if such an application program accesses a timestamp counter, the timestamp counter value provided by the first processor may not necessarily be synchronized with the timestamp counter value provided by the second processor.

Even single-node computing systems, in which there are one or more processors, may suffer from timing issues relating to access of the internal timestamp counters of the processors. Some processors cannot increment their internal timestamp counters at a fixed rate, even though some operating systems and application programs expect that this rate is constant. Furthermore, some processors stop incrementing their internal timestamp counters when entering various power-conservation modes, which can be problematic for operating systems and application programs that do not allow for this.

A limited solution to these programs is to use a counter that is external to the internal timestamp counter of a processor. Two such examples are the advanced configuration and power interface (ACPI) power management (PM) timer counter, and the high-precision event timer (HPET) counter. Both the ACPI PM counter and the HPET counter increment at a constant rate. There may be one such counter within a given system, so there is no issue as to counter synchronization as there is with the internal timestamp counters of multiple processors.

However, this solution is disadvantageous in some respects. HPET counters are only supported in the most recent operating systems, which means that they cannot be used in relation to older operating systems. Furthermore, accessing ACPI PM counters and HPET counters is typically slower than accessing internal timestamp counters of processors. As a result, the performance of operating systems and application programs can suffer.

Finally, many application programs have been written to specifically access the internal timestamp counters of processors. As a result, these application programs would have to be rewritten, or at least recompiled, for them to instead take advantage of external counters like HPET counters and ACPI PM counters. Therefore, even where such external counters are available, in many cases this availability does little to address the problems associated with internal timestamp counters of processors, since existing programs may have been developed to solely access these internal timestamp counters.

For these and other reasons, therefore, there is a need for the present invention.

### SUMMARY OF THE INVENTION

The present invention relates to processing internal timestamp counter instructions in reference to an external counter instead. In a method of one embodiment of the invention, a processor receives an instruction to access an internal timestamp counter of the processor, such as from software code containing the instruction that is currently being executed by the processor. The processor processes the instruction, however, in reference to an external counter apart from the processor, instead of in reference to the internal timestamp counter of the processor. As a result, the software code is unaware that the instruction is being processed in reference to the external counter instead of in reference to the internal timestamp counter, and furthermore does not have to be rewritten or recompiled to take advantage of the external counter. That is, the software code still has instructions that are intended to access the internal timestamp counter of a processor, and these instructions are instead executed in reference to an external counter, such as a phase-locked loop (PLL) clock of a Northbridge controller.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a system, such as a computing node, in which instructions to access an internal timestamp counter of a processor are instead processed in reference to an external counter apart from the processor, according to an embodiment of the invention.

FIG. 2 is a diagram of a multiple-node computing or computerized system, in which instructions to access an internal timestamp counter of a processor are instead processed in reference to an external counter apart form the processor, according to an embodiment of the invention.

FIG. 3 is a flowchart of a method processing internal timestamp counter instructions in reference to an external counter instead of in reference to an internal timestamp counter, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

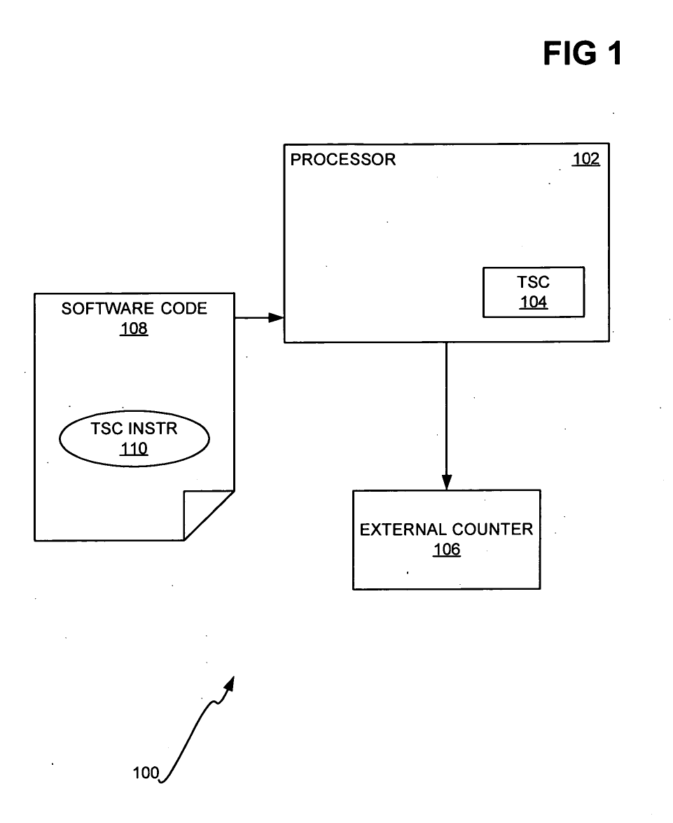

FIG. 1 shows a system 100, according to an embodiment of the invention. The system 100 may be a single computing node, such as a single computing device, and includes a processor 102 having an internal timestamp counter 104, as well as an external counter 106. As can be appreciated by those of ordinary skill within the art, the system 100 can and typically will have other components, in addition to those depicted in FIG. 1.

The processor 102 is executing software code 108. The software code 108 may be part of an application computer program, an operating system, or another type of computer program. The software code 108 includes an internal timestamp counter instruction 110 to access the internal timestamp counter 104 of the processor 102. The timestamp counter 104 is an internal timestamp counter in that it is part of the processor 102, and thus internal to the processor 102.

The internal timestamp counter instruction 110 may be a read instruction to read a current value of the internal timestamp counter 104 of the processor 102. Alternatively, the internal timestamp counter instruction 110 may be a write instruction to write a new value to the internal timestamp counter 104 of the processor 102. The internal timestamp counter instruction 110 may also be another type of instruction that is to access the internal timestamp counter 104 of the processor 102.

When the processor 102 receives the internal timestamp counter instruction 110, such that it is to execute the instruction 110 of the software code 108, however, it does not process the instruction in reference to the internal timestamp counter 104 of the processor 102. That is, in the case of a read instruction, the processor 102 does not read and return the current value of the internal timestamp counter 104. Likewise, in the case of a write instruction, the processor 102 does not write the provided new value to the internal timestamp counter 104.

Rather, the processor 102 instead processes the internal timestamp counter instruction 110 in reference to the external counter 106. The external counter 106 is external in that it is apart from the processor 102, and not a part of and thus external to the processor 102. Thus, in the case of a read instruction, the processor 102 reads and returns the current value of the external counter 106. Likewise, in the case of a write instruction, the processor 102 writes the provided new value to the external counter 106.

Therefore, the software code 108 that issues and contains or includes the internal timestamp counter instruction 110 can be unaware that the instruction 110 is being processed by the processor 102 in reference to the external counter 106 instead of in reference to the internal timestamp counter 104. Indeed, the instruction 110 is expected by the software code 108 to be processed in reference to the internal timestamp counter 104, since the instruction 110 is an internal timestamp counter instruction. However, instead the instruction 110 is processed by the processor 102 in reference to the external counter 106.

The software code 108 therefore does not have to be recompiled or rewritten to take advantage of the external counter 106. Rather, the processor 102 is initially programmed so that when it receives instructions relating to the internal timestamp counter 104, the processor 102 instead processes the instructions in relation to the external counter 106. As a result, embodiments of the invention avoid at least some of the disadvantages associated with the prior art as recited in the background section. The processor 102 can be programmed to reference the external counter 106 when receiving instructions that are intended to reference the internal timestamp counter 104, regardless of the operating system being employed.

That is, the solution provided by at least some embodiments of the invention is amenable to both older operating systems and newer operating systems, unlike high-precision event timer (HPET) counters. Moreover, application programs do not have to be written or rewritten to specifically access the external counter 106. That is, even if they have been written to specifically access the internal timestamp counter 104, the application programs upon execution by the processor 102 nevertheless in actuality access the external counter 106 within at least some embodiments of the invention, unlike HPET counters and advanced configuration and power interface (ACPI) power management (PM) timer counters.

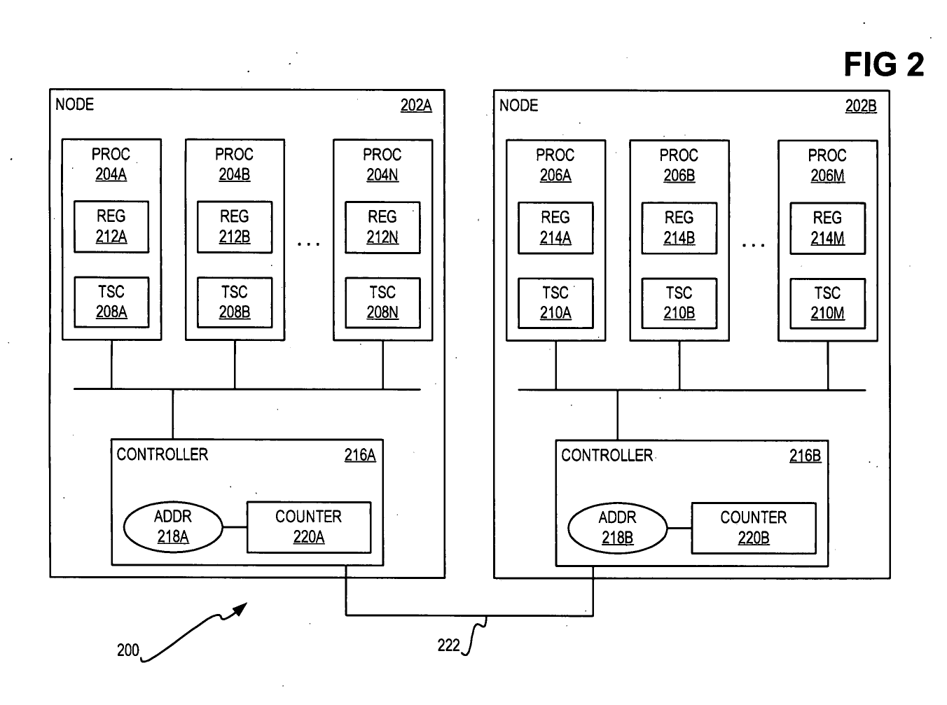

FIG. 2 shows a multiple-node system 200, according to an embodiment of the invention. The system 200 is depicted as including two nodes 202A and 202B, collectively referred to as the nodes 202, but there may be more than two of the nodes 202 in one embodiment. Each of the nodes 202 may be considered a separate computing device, but which cooperates with the other nodes 202 to provide a single system 200 that has increased performance over just one of the nodes 202.

The node 202A includes multiple processors 204A, 204B, . . . , 204N, collectively referred to as the processors 204, whereas the node 202B includes multiple processors 206A, 206B, . . . , 206M, collectively referred to as the processors 206. The nodes 202 also include controllers 216A and 216B, collectively referred to as the controllers 216, and which may be Northbridge controllers, or other types of controllers. As can be appreciated by those of ordinary skill within the art, the nodes 202 can and typically do include other components, besides those depicted in FIG. 2.

The processors 204 of the node 202A include internal timestamp counters 208A, 208B, . . . , 208N, collectively referred to as the timestamp counters 208, such that each of the processors 204 has its own corresponding one of the timestamp counters 208. Likewise, the processors 206 of the node 202B include internal timestamp counters 210A, 210B, . . . , 210M, collectively referred to as the timestamp counters 210, such that each of the processors 206 has its own corresponding one of the timestamp counters 210. The-controller 216A also has a counter 220A with an associated address 218A, and the controller 216B has a counter 220B with an associated address 218B that is different than the address 218A. The counters 220A and 220B are external to and separate and apart from the processors 204 and 206.

The processors 204 of the node 202A further include registers 212A, 212B, . . . , 212N, collectively referred to as the registers 212. The processors 204 are programmable via their registers 212 to reference an external counter instead of their internal timestamp counters 208 in response to instructions relating to the internal timestamp counters 208. For example, the registers 212 may each be enabled, and set to specify the address 218A of the counter 220A of the controller 216A. As a result, when any of the processors 204 receives an instruction relating to its corresponding one of the internal timestamp counters 208, it instead processes the instruction in reference to the counter 220A.

The processors 206 of the node 202B also include registers 214A, 214B, . . . , 214M, collectively referred to as the registers 214. The processors 206 are programmable via their registers 214 to reference an external counter instead of their internal timestamp counters 210 in response to instructions relating to the internal timestamp counters 210. For example, the registers 214 may each be enabled, and set to specify the address 218B of the counter 220B of the controller 216B. As a result, when any of the processors 204 receives an instruction relating to its corresponding one of the internal timestamp counters 210, it instead processes the instruction in reference to the counter 220B of the controller 216B.

However, in one embodiment, the registers 212 and 214 of the processors 204 and 206 of the nodes 202 are all enabled and set to specify the same external counter. For instance, the registers 212 and 214 may specify the address 218A of the counter 220A of the controller 216A of the node 202A. As a result, when any of the processors 204 and 206 receive an instruction relating to its corresponding one of the internal timestamp counters 208 and 210, it instead processes the instruction in reference to the counter 220A of the controller 216A.

The nodes 202A and 202B are communicatively connected to one another via a link 222, such as a scalability link. Therefore, when one of the processors 206 of the node 202B in the embodiment described in the previous paragraph encounters or receives an internal timestamp counter instruction, it references the counter 220A via the controller 216B of the node 202B communicating with the controller 216A of the node 202A. By comparison, when one of the processors 204 of the node 202A in this embodiment encounters or receives an internal timestamp counter instruction, it references the counter 220A via the controller 216A directly.

In this way, at least some embodiments of the invention provide for further advantages over the prior art. Timing issues that result from internal timestamp counters of different processors 204 and 206 not being synchronized with one another are avoided. This is because all of the processors 204 and 206 process internal timestamp counter instructions in relation to the same external counter, such as the counter 220A of the controller 216A.

Furthermore, where the controller 216A is a Northbridge controller and where the counter 220A is a phase-locked loop (PLL) counter or timer, the counter 220A is incremented at a constant rate. As a result, timing issues resulting from the timestamp counters 208 and 210 not being incremented at a fixed or constant rate are avoided. Finally, while accessing the counter 220A is slower than accessing the internal timestamp counters 208 and 210, such access is nevertheless faster than accessing ACPI PM counters, and generally is as fast as accessing HPET counters that cannot be incremented at a constant rate and that are supported only in newer operating systems.

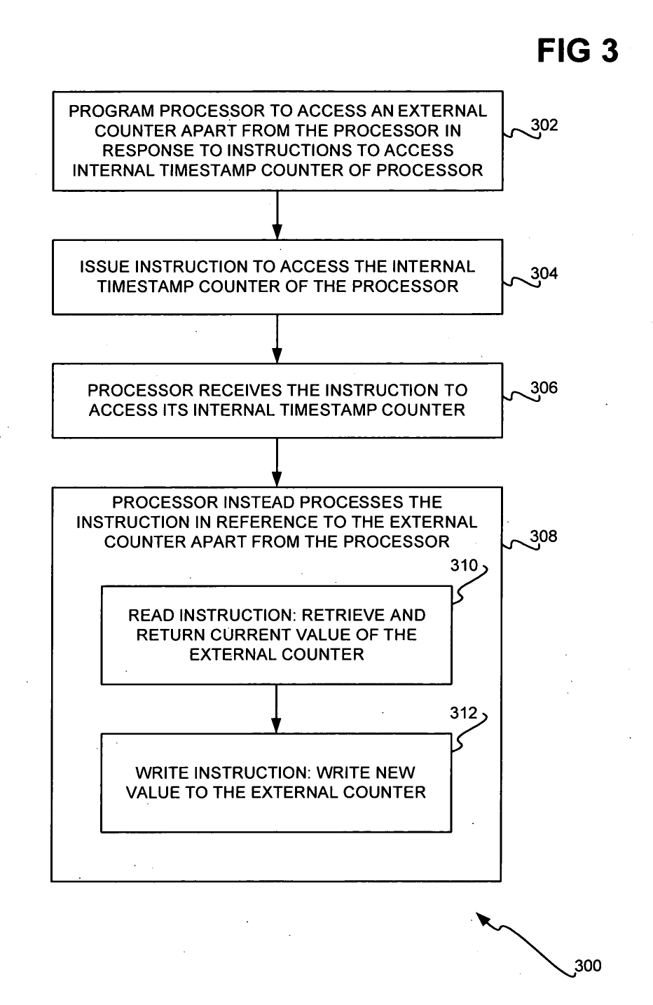

FIG. 3 shows a method 300, according to an embodiment of the invention. The method 300 may be implemented as one or more computer programs stored on a tangible computer-readable medium, such as a recordable data storage medium, of an article of manufacture. That is, embodiments of the invention can take the form of a computer program product accessible from a computer-usable or tangible computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a tangible computer-readable medium include a semiconductor or solid-state memory, magnetic tape, a removable computer diskette, a random access memory (RAM), a read-only memory (ROM), a rigid magnetic disk and an optical disc. Current examples of optical discs include a compact disc-read only memory (CD-ROM), a compact disc-read/write (CD-RW) and a digital versatile disc (DVD).

The method 300 first programs a processor to access an external counter apart from the processor itself, when responding to instructions to access the internal timestamp counter of the processor (302). For instance, a register, such as a machine-specific register (MSR), of the processor may be enabled, and set to specify the address of the external counter within the system of which the processor is a part. Examples of such internal timestamp counter instructions include read instructions, such as the rdmsr or the rdtsc processor instruction, to read the current value of the counter, as well as write instructions, such as the wrmsr processor instruction, to write a new value to the counter.

Thereafter, such an internal timestamp counter instruction is issued to access the internal timestamp counter of the processor (304). For instance, software code may contain such an instruction, where the instruction is being executed by the processor. The instruction may be a read instruction or a write instruction, as has been described. It can thus be said that the processor receives the instruction to access its internal timestamp counter (306).

However, in response, the processor processes the internal timestamp counter instruction in reference to or in relation to the external counter apart from the processor, instead of in reference to or in relation to its internal timestamp counter (308). Thus, instructions such as rdmsr, rdtsc, and wrmsr processor instructions within the software code that normally are to access the internal timestamp counter instead access the external counter programmed in the processor's register, such as an MSR of the processor. The software code does not have to be rewritten or recompiled for this change to occur, and furthermore, the software code has no knowledge that the change has occurred, such that it is unaware that the counter being accessed is an external counter and not the internal timestamp counter of the processor itself.

Where the internal timestamp counter instruction is a read instruction, then, the processor retrieves and returns the current value of the external counter to process the instruction in reference to the external counter instead of in reference to the internal timestamp counter (310). Where the internal timestamp counter instruction is a write instruction, the processor writes the provided new value to the external counter to process the instruction in reference to the external counter instead of in reference to the internal timestamp counter (312). In both instances, although the instruction relates to the internal timestamp counter, the instruction is instead processed in reference to the external counter.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
receiving by a processor an instruction to access an internal timestamp counter of the processor; and,
processing the instruction by the processor in reference to an external counter apart from the processor instead of in reference to the internal timestamp counter of the processor.

2. The method of claim 1, further comprising initially issuing the instruction to the processor by software code containing the instruction, such that the software code is unaware that the instruction is processed by the processor in reference to the external counter apart from the processor instead of in reference to the internal timestamp counter of the processor.

3. The method of claim 1, wherein receiving by the processor the instruction to access the internal timestamp counter of the processor comprises receiving a read instruction to read a current value of the internal timestamp counter of the processor.

4. The method of claim 3, wherein the read instruction comprises one of a rdmsr processor instruction and a rdtsc processor instruction.

5. The method of claim 3, wherein processing the instruction by the processor comprises:
retrieving a current value of the external counter apart from the processor; and,
returning the current value of the external counter in response to the instruction to access the internal timestamp counter of the processor.

6. The method of claim 1, wherein receiving by the processor the instruction to access the internal timestamp counter of the processor comprises receiving a write instruction to write a new value to the internal timestamp counter of the processor.

7. The method of claim 6, wherein the write instruction comprises a wrmsr processor instruction.

8. The method of claim 6, wherein processing the instruction by the processor comprises writing the new value to the external counter apart from the processor in response to the instruction to access the internal timestamp counter of the processor.

9. The method of claim 1, further comprising initially programming the processor to access the external counter apart from the processor in response to instructions received to access the internal timestamp counter of the processor.

10. The method of claim 9, wherein programming the processor to access the external counter apart from the processor in response to instructions received to access the internal timestamp counter of the processor comprises enabling a corresponding machine-specific register (MSR) of the processor.

11. A computerized system comprising:
one or more nodes, each node having a plurality of processors;
an internal timestamp counter located at each processor of each node; and,
an external counter located at one of the nodes,
wherein each processor is responsive to instructions to access the internal timestamp counter of the processor, and is programmed to process the instructions in reference to the external counter instead of in reference to the internal timestamp counter.

12. The system of claim 11, wherein the external counter comprises a phase-locked loop (PLL) clock.

13. The system of claim 11, wherein the external counter is located at a Northbridge controller of the one of the nodes.

14. The system of claim 11, wherein each processor comprises a machine-specific register (MSR) corresponding to the internal timestamp counter of the processor, the MSR of each processor enabled so that the instructions to access the internal timestamp counter are instead processed in reference to the external counter.

15. The system of claim 11, wherein the instructions comprise:
a read instruction to read a current value of the internal timestamp counter, and which is instead processed to read a current value of the external counter; and,
a write instruction to write a new value to the internal timestamp counter, and which is instead processed to write the new value to the external counter.

16. The system of claim 15, wherein the read instruction comprises one of a rdmsr processor instruction and a rdtsc processor instruction, and the write instruction comprises a wrmsr processor instruction.

17. The system of claim 11, wherein the one or more nodes comprises a single node.

18. The system of claim 11, wherein the one or more nodes comprises a plurality of nodes communicatively connected to one another.

19. An article of manufacture comprising:
a tangible computer-readable medium; and,
means in the medium for programming a processor to access an external counter apart from the processor in response to instructions received by the processor to access an internal timestamp counter of the processor,
such that software code containing the instructions to the processor is unaware that the instructions are processed by the processor in reference to the external counter apart from the processor instead of in reference to the internal timestamp counter of the processor.

20. The article of manufacture of claim 19, wherein the means is for programming the processor to access the external counter apart from the processor in response to instructions received to access the internal timestamp counter of the processor by enabling a corresponding machine-specific register (MSR) of the processor.
